(19) United States
(12) Patent Application Publication
(10) Pub. No.: US 2010/0174486 A1
(43) Pub. Date: Jul. 8, 2010

(54) VEHICLE POSITION SPECIFYING DEVICE, VEHICLE POSITION SPECIFYING METHOD, AND DRIVING ASSISTANCE DEVICE

(75) Inventor: Isao Wakabayashi, Kobe-shi (JP)

Correspondence Address: OLIFF & BERRIDGE, PLC, P.O. BOX 320850, ALEXANDRIA, VA, 22320-4850, US

(73) Assignee: FUJITSU TEN LIMITED, Kobe-shi (JP)

(21) Appl. No.: 12/449,348

(22) PCT Filed: Mar. 28, 2008
(86) PCT No.: PCT/JP2008/056189

§ 371 Date: Aug. 4, 2009

(30) Foreign Application Priority Data
Mar. 30, 2007 (JP) 2007-094852

(51) Int. Cl. G01S 19/31; G01C 21/00

(52) U.S. Cl. 701/214; 342/357.02

(57) ABSTRACT

A vehicle position specifying device includes a reception unit that is installed in a vehicle and receives radio waves transmitted from a positioning satellite, a measurement unit that measures coordinates of the reception unit based on a reception result of the reception unit, a communication unit that acquires vehicle-position information on a position of an own vehicle from outside the vehicle, and a calculation unit that calculates an installation position of the reception unit in the vehicle based on the coordinates of the reception unit and the vehicle-position information.

### TECHNICAL FIELD

The present invention relates to a vehicle position specifying device, a vehicle position specifying method, and a driving assistance device for specifying a position of an own vehicle using GPS, and more particularly, to a vehicle position specifying device, a vehicle position specifying method, and a driving assistance device of high accuracy using a quasi-zenith satellite.

### BACKGROUND ART

Conventionally, there has been used a so-called car navigation system in which a GPS unit for receiving radio waves from a positioning satellite and specifying a position of an own terminal is installed in a vehicle and used to obtain information for route guide up to a destination and information on local facilities.

Besides, in recent years, use of a quasi-zenith satellite allows more highly accurate positioning of an own terminal, and new services such as lane change guide are created using this system.

Here, coordinates measured by GPS indicate a position of a receiver of the GPS unit. However, an error caused by change in position of the receiver in a vehicle is no longer negligible in services using high-accuracy position information.

Therefore, for example, Patent document 1 discloses a technology for detecting an installation position of an antenna in a vehicle based on reception condition of radio waves from a quasi-zenith satellite. Patent document 2 discloses a technology for receiving position correction data through communications with a center and correcting data on detected position of an accident. Likewise, Patent document 3 discloses a technology for correcting a GPS positioning value by calculating an error between a measurement result of conventional GPS and a measurement result obtained by using the quasi-zenith satellite in the center side and providing error data to each vehicle.

[Patent document 1] Japanese Laid-open Patent Publication No. 2006-78374

[Patent document 2] Japanese Laid-open Patent Publication No. 2004-144709

[Patent document 3] Japanese Laid-open Patent Publication No. 2005-156248

### DISCLOSURE OF INVENTION

### Problem to be Solved by the Invention

However, the conventional technologies assume that a process such as communications with the center is actively performed to improve positioning accuracy. Therefore, there remains a problem that if the process is not performed, the functions disclosed in the technologies cannot be performed fully.

In the conventional technologies, it is not taken into account that the GPS unit may be added to the vehicle afterward by users or that a location of a GPS receiver may be changed by its replacement. Therefore, if the users do not know that a correction process is required, the correction process is not appropriately performed. Thus, there is a danger that services may be provided based on incorrect position information.

Moreover, the conventional technologies do not take into account that highly accurate positioning is not always required for all location-based services provided by an in-vehicle unit.

The present invention has been achieved to solve problems in the conventional technologies, and an object is to provide a vehicle position specifying device, a vehicle position specifying method, and a driving assistance device capable of improving positioning accuracy without burdening users and providing appropriate services according to the positioning accuracy.

### Means for Solving Problem

To solve the problems as described above and to achieve an object, a vehicle position specifying device, a vehicle position specifying method, and a driving assistance device receive radio waves transmitted from a positioning satellite to measure coordinates, acquire vehicle-position information on a position of an own vehicle from outside the vehicle, and calculate an installation position of a reception unit in the vehicle based on coordinates of the reception unit and the vehicle-position information.

### EFFECT OF THE INVENTION

According to the present invention, the vehicle position specifying device, the vehicle position specifying method, and the driving assistance device are configured to specify an installation position of a GPS receiver using vehicle position information obtained from outside the vehicle. Therefore, it is possible to obtain the vehicle position specifying device, the vehicle position specifying method, and the driving assistance device capable of improving the positioning accuracy of an own vehicle and thereby providing appropriate services according to the positioning accuracy.

### BRIEF DESCRIPTION OF DRAWINGS

FIG. 1 is a schematic diagram for explaining an overview of the present invention.

FIG. 2 is a schematic diagram for explaining a general configuration of an in-vehicle unit according to an embodiment of the present invention.

FIG. 3 is a schematic diagram for explaining arrangement of cameras provided in roadside equipment.

FIG. 4 is a schematic diagram for explaining levels of reliability and selection of services to be provided.

FIG. 5 is a flowchart for explaining process operations of the in-vehicle unit and the roadside equipment.

FIG. 6 is a flowchart for explaining a vehicle-position-coordinates calculation process.

FIG. 7 is a schematic diagram for explaining a specific example of image processing.

### EXPLANATIONS OF LETTERS OR NUMERALS

10 in-vehicle unit
11 GPS receiver
12 navigation unit
13 collision avoidance unit
14 in-vehicle notification system
15 operation control system
16 inter-vehicle communication unit
20 installation-information management unit
21, 34 road-to-vehicle communication unit
22 provided-service selection unit
30 roadside equipment
31, 32 camera
33 vehicle-position calculation unit

### BEST MODE(S) FOR CARRYING OUT THE INVENTION

Preferred embodiments of a vehicle position specifying device, a vehicle position specifying method, and a driving assistance device according to the present invention will be explained in detail below with reference to the accompanying drawings.

### Embodiment

### 1. Overview of Invention

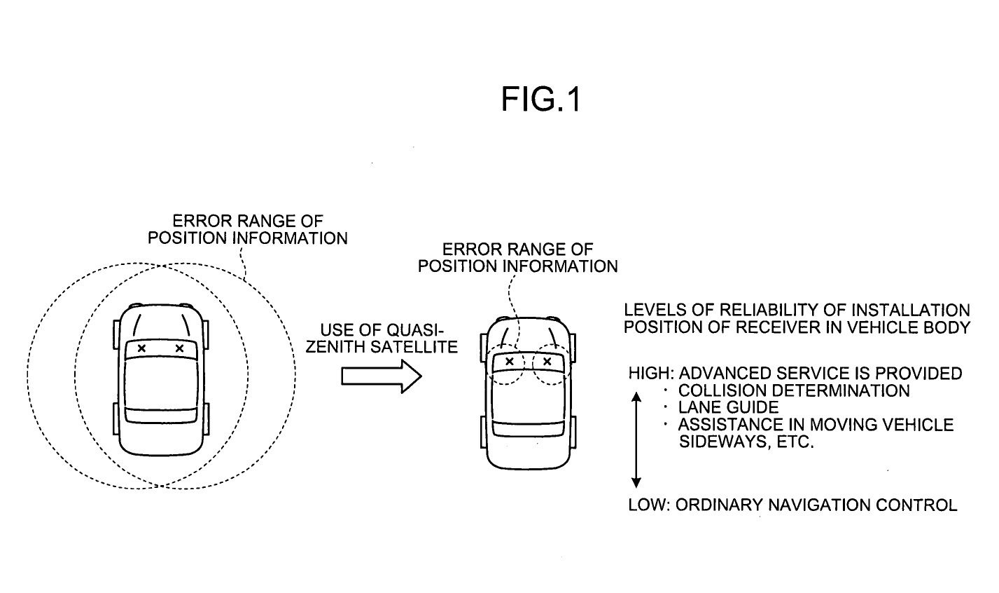

Firstly, an overview of the present invention is explained with reference to FIG. 1. In conventional GPS using only a positioning satellite, an error of several meters occurs in positioning. Therefore, it is not a significant matter that position of a receiver that receives radio waves from the positioning satellite may change in the vehicle according to its placement.

However, when the quasi-zenith satellite is used for GPS, an error is about several centimeters. Therefore, if any service that makes full use of the accuracy is provided, it is important to correctly determine the position of an installed receiver on a vehicle body.

If a GPS receiver is installed by a manufacturer or a dealer, its accurate installation position in the vehicle body is registered at that time. In many cases, however, the GPS receiver is added afterward or is replaced with some other one by users. In these cases, a registered position cannot be always expected to be an accurate installation position of the receiver.

Therefore, the present invention is configured to set levels of reliability of an installation position of the receiver in the vehicle body, and select a service to be provided according to the level of reliability. For example, if the level of reliability is low, ordinary navigation control is provided; and if the level of reliability is relatively high, lane change guide is provided additionally. If the level of reliability is sufficiently high, services such as determination of a collision with other vehicles and assistance in moving a vehicle sideways are provided.

### 2. Configuration Example of Present Invention

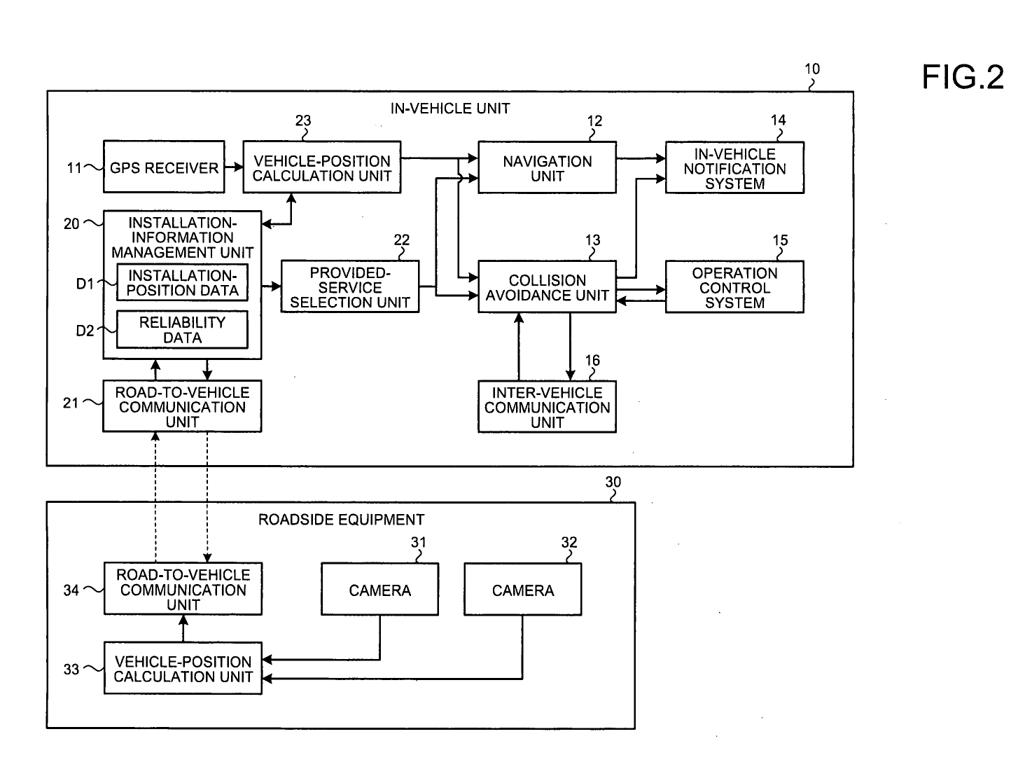

FIG. 2 is a schematic diagram of a general configuration of an in-vehicle unit 10 according to an embodiment of the present invention. As shown in this figure, the in-vehicle unit 10 includes a GPS unit 11, a navigation unit 12, a collision avoidance unit 13, an in-vehicle notification system 14, an operation control system 15, an inter-vehicle communication unit 16, an installation-information management unit 20, a road-to-vehicle communication unit 21, and a provided-service selection unit 22.

The GPS receiver 11 is a reception unit that receives radio waves transmitted from a plurality of positioning satellites including a quasi-zenith satellite. A vehicle-position calculation unit 23 calculates vehicle-position information of a vehicle, in which the in-vehicle unit 10 is installed, by using a reception result of the GPS receiver 11, and provides the calculated information to the navigation unit 12 and the collision avoidance unit 13.

When low-accuracy positioning is performed using only the conventional positioning satellite, the coordinates of the receiver may be output as they are and used as vehicle position information. However, the vehicle-position calculation unit 23 is configured to provide services using high-accuracy position information. Therefore, the vehicle-position calculation unit 23 acquires installation-position data D1 managed by the installation-information management unit 20, calculates the vehicle-position information based on the coordinates of the receiver and installation-position data, and outputs the calculated information.

The navigation unit 12 is a unit that provides information on local facilities and roads using the vehicle-position information output from the vehicle-position calculation unit 23 and also using map data (not shown) or the like, and that guides the vehicle to a destination. If services that require high-accuracy position information are selected by the provided-service selection unit 22, the navigation unit 12 can provide services that require high-accuracy position information, for example, a lane guide service for guiding the vehicle to a driving lane and a service for assisting the vehicle to move sideways.

The collision avoidance unit 13 is a unit that determines possibility of occurrence of a collision and performs a process for avoiding the occurrence of the collision, using the vehicle-position information output from the vehicle-position calculation unit 23, information on adjacent vehicles acquired when the inter-vehicle communication unit 16 communicates with other vehicles, and using information on a vehicle operating state such as speed information acquired from the operation control system 15.

The in-vehicle notification system 14 is a group of devices such as a speaker and a display that provides information to a vehicle occupant, and is used when the navigation unit 12 outputs information and when the collision avoidance unit 13 notifies a danger. Moreover, the in-vehicle notification system 14 can be shared by other devices such as an audio device.

The operation control system 15 is a group of devices that controls operations of the vehicle, such as an engine control ECU, a transmission-mechanism control ECU, and a brake ECU, and that provides an operating state of the vehicle to the collision avoidance unit 13 and is controlled by the collision avoidance unit 13.

The installation-information management unit 20 stores therein an installation position of the receiver 11 in the vehicle, i.e., relative position information, as installation-position data D1, and levels of reliability of the installation position as reliability data D2.

The installation-position data D1 is determined by comparing coordinates (absolute-position information) of the GPS receiver 11 acquired from the vehicle-position calculation unit 23 with position information of the own vehicle that the road-to-vehicle communication unit 21 receives from a roadside equipment 30, and the reliability data D2 is determined from information or the like used to create the installation-position data D1.

The installation-position data D1 created in the above manner is output to the vehicle-position information calculation unit 23 and is used to calculate a vehicle position. The reliability data D2 is output to the provided-service selection unit 22. The provided-service selection unit 22 selects a service that can be provided based on the level of reliability shown in the reliability data D2, and notifies the navigation unit 12 and the collision avoidance unit 13 of the selected service.

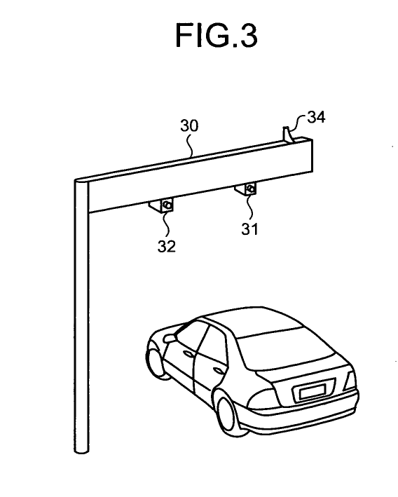

The road-to-vehicle communication unit 21 communicates with the roadside equipment 30 through, for example, DSRC. The roadside equipment 30 includes a road-to-vehicle communication unit 34 that communicates with the in-vehicle unit 10, cameras 31 and 32, and a vehicle-position calculation unit 33. The cameras 31 and 32 simultaneously take images of the vehicle from different positions, for example, as shown in FIG. 3. The vehicle-position calculation unit 33 calculates a vehicle position through image recognition of the two obtained images, and transmits the vehicle position to the in-vehicle unit 10 through the road-to-vehicle communication unit 34.

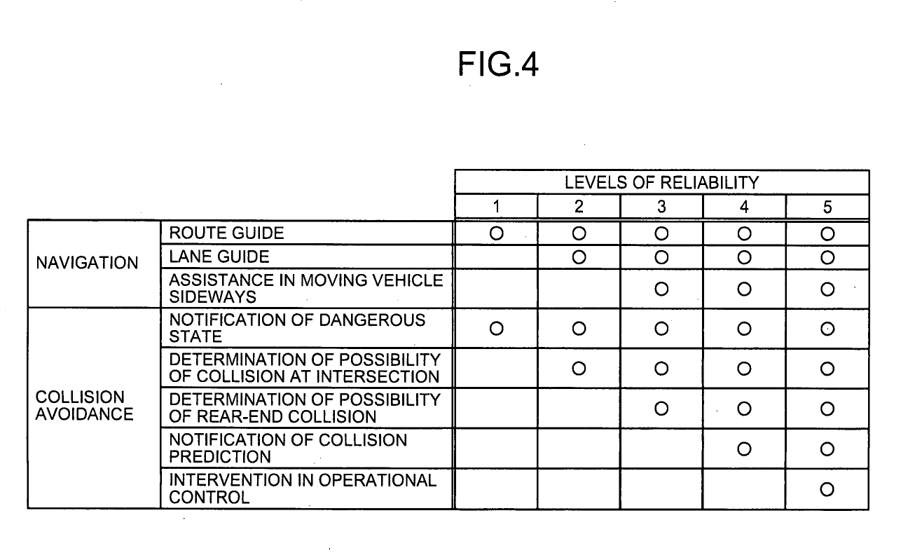

Subsequently, the selection of services by the provided-service selection unit 22 is further explained below. FIG. 4 is a specific example of a correlation between levels of reliability and selection of services to be provided. In this figure, the navigation unit 12 has functions of route guide, lane guide, and assistance in moving a vehicle sideways.

The route guide is a service to set a route up to a destination and output information so that a driver can drive along the route, and this service is provided even if a value of the reliability data D2 is “1” which is the lowest.

The lane guide is a service to set a lane, along which the own vehicle should travel, and output information so as to appropriately change the lane. To use this function, it is necessary to specify the lane, along which the own vehicle is traveling. Therefore, this service is provided only when the level of reliability is 2 or higher and a relatively high level of accuracy can be expected in the position of the own vehicle determined using the installation-position data.

The assistance in moving a vehicle sideways is a service to determine how much space is between the own vehicle and a side obstacle (for example, wall) and to output information such as “30 more centimeters left to move leftward”. For this service, it is necessary to specify the position of the own vehicle with an accuracy higher than an operation amount by which the vehicle is controlled to move sideways according to this service. Therefore, this service is provided only when the level of reliability is 3 or higher. A shape of the own vehicle is not explained herein because it is sufficient if the shape of the vehicle is stored beforehand as data in an arbitrary format.

In FIG. 4, the collision avoidance unit 13 has functions such as notification of a dangerous state, determination of possibility of a collision at an intersection, determination of possibility of a rear-end collision, notification of collision prediction, and intervention in operational control.

The notification of a dangerous state is a service to determine possibility of occurrence of a dangerous state based on, for example, a state of the own vehicle and a state of an adjacent vehicle and to notify the driver of the possibility, and this service is provided even if the level of reliability is “1”.

Meanwhile, the determination of possibility of a collision at an intersection is a service to determine possibility of a collision when the own vehicle or the adjacent vehicle turns right or left, and to notify the driver of the possibility. For this service, it is necessary to recognize along which lanes the own vehicle and the adjacent vehicle are traveling. Therefore, this service is provided only when the level of reliability is 2 or higher.

Likewise, the determination of possibility of a rear-end collision is a service to determine possibility of a collision between the own vehicle and another vehicle and to notify the driver of the possibility. For this service, it is necessary to recognize a following distance between the own vehicle and the adjacent vehicle with a relatively high level of accuracy. Therefore, this service is provided only when the level of reliability is 3 or higher.

The notification of collision prediction is a service to predict that there is a high possibility of occurrence of a collision accident in the own vehicle and to warn the driver of the high possibility. For this service, it is necessary to recognize the position of the own vehicle with high accuracy. Therefore, this service is provided only when the level of reliability is 4 or higher.

The intervention in operational control is a service to forcibly intervene vehicle operation when the possibility of a collision accident of the own vehicle is very high and it is difficult for the driver to avoid the collision by his/her control, and to automatically execute control operation or the like. For this service, it is necessary to specify the position of the own vehicle with extremely high accuracy, and the result of collision prediction is required to be sufficiently accurate. Therefore, this service is provided only when the level of reliability is 5.

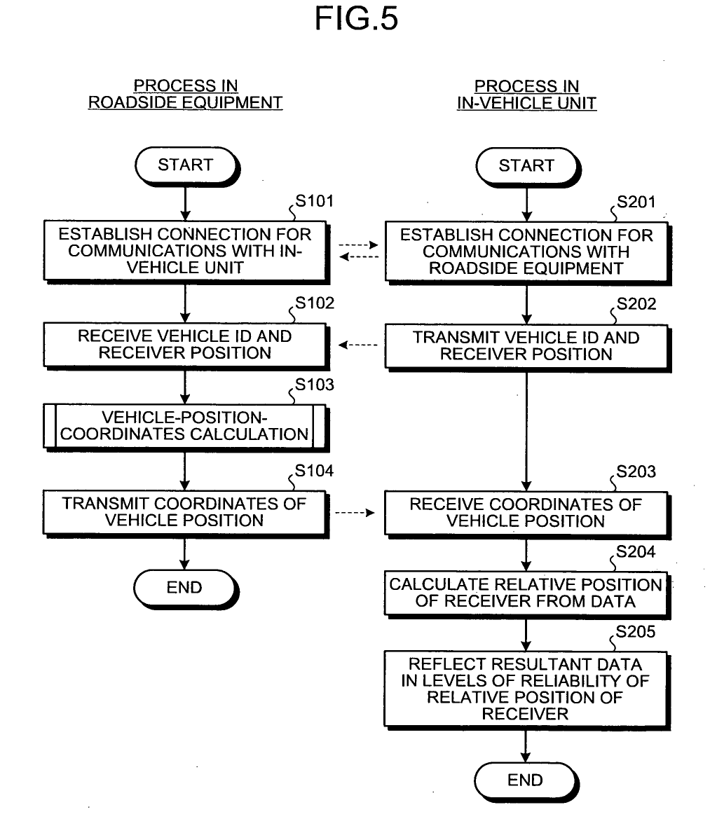

Next, process operations of the roadside equipment 30 and the in-vehicle unit 10 are explained below with reference to FIG. 5. A flowchart shown in this figure is started when the vehicle in which the in-vehicle unit 10 is installed approaches the roadside equipment 30.

First, the roadside equipment 30 and the in-vehicle unit 10 establish a connection for road-to-vehicle communications (Steps S101, S201). Thereafter, the in-vehicle unit 10 transmits ID of the own vehicle and a receiver position (absolute coordinates of the receiver measured by GPS) to the roadside equipment 30 (Step S202). Then, the roadside equipment 30 receives the data (Step S102), calculates coordinates of a position of the vehicle (Step S103), transmits the coordinates to the in-vehicle unit 10 (Step S104), and ends the process.

The in-vehicle unit 10 receives the coordinates of the position of the own vehicle from the roadside equipment 30 (Step S203), calculates a relative position of the receiver using the received data, and sets the calculated position as installation-position data D1 (Step S204). Then, the calculated result is reflected in the reliability data D2 (Step S205), and the process is ended.

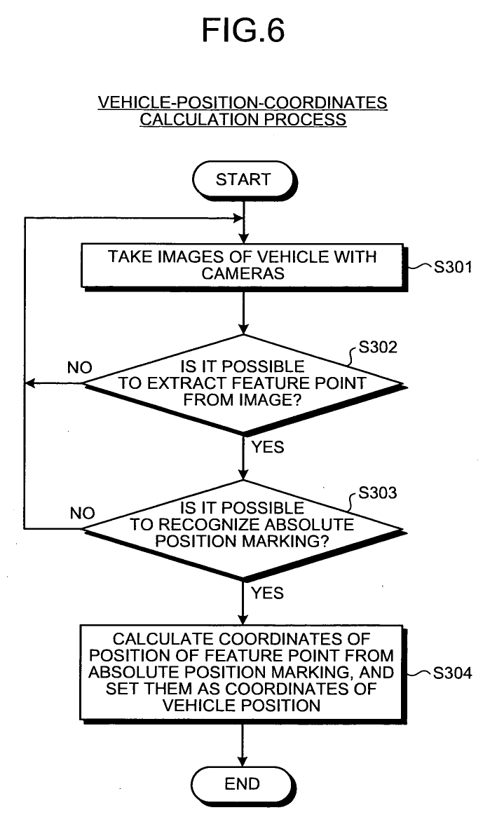

Details of vehicle-position-coordinates calculation shown at Step S103 in FIG. 5 are shown in FIG. 6. As shown in this figure, the vehicle-position-coordinates calculation is implemented by taking images of the vehicle with the cameras (Step S301), determining whether feature points can be extracted from the images (Step S302), and when the feature points can be determined (Yes at Step S302), then further determining whether an absolute position marking can be recognized (Step S303).

When the feature point cannot be extracted (No at Step S302) and the absolute position marking cannot be recognized (No at Step S303), the process is repeated from taking images of the vehicle with the cameras (Step S301).

When an absolute value marking can be recognized (Yes at Step S303), coordinates of the position of the feature point on the road are calculated from the absolute position marking, and the coordinates are set as vehicle-position information (Step S304), and then the process is ended.

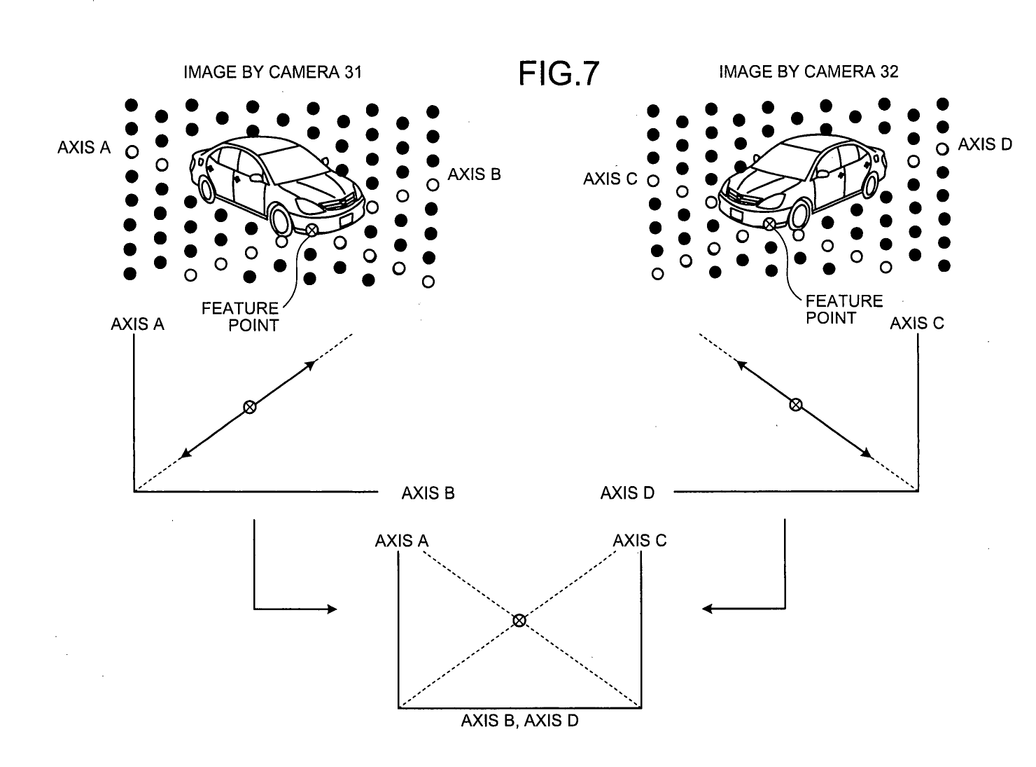

The position coordinates calculation through the image recognition is further explained with reference to FIG. 7. In this figure, the camera 31 and the camera 32 take images of one vehicle from different positions. Feature points are extracted from the respective images, and the absolute value marking corresponding to each of the feature points is recognized based on two axes in each of the images.

In this figure, an edge of the vehicle is used as the feature points of the images of the vehicle, however, if headlights, brake lights, or side lights are turned on, it is preferable to use them.

The absolute value marking is a marker placed on the road in the image through a software process, and the position of the vehicle on the road is specified based on the absolute position marking corresponding to the position of the feature point in the images of the vehicle.

However, because the feature points obtained from the images of the vehicle include its height, the position cannot be specified from the image in one direction. For example, as the feature point obtained from the image taken by the camera 31, its position in the image can be specified by an axis A and an axis B, however, if the position in the image is developed to that on the road, there is a displacement in a component in its height direction. Likewise, for the feature point obtained from the image taken by the camera 32, the position in the image can be specified by an axis C and an axis D, however, there remains a displacement in the height component.

Therefore, the images taken by the camera 31 and the camera 32 are combined. This allows calculation of the position of the feature point.

The roadside equipment 30 transmits the extracted feature points, the calculated position of the feature point, and data acquisition time to the in-vehicle unit 10. The in-vehicle unit 10 calculates the installation-position data D1 using these data, absolute coordinates of the receiver 11 at the data acquisition time (photographed time in the roadside equipment 30), and further using the shape of the vehicle.

Further, the level of reliability is calculated in the following manner. Firstly, as a factor of the level of reliability or as a factor of an error in a relative position of the receiver to the vehicle body, an external environment, a speed of the own vehicle, the number of feature points, and the number of measurement times are considered.

As for the external environment, it is considered that an error in an absolute position used to calculate the relative position is mainly caused by a multipath received from the positioning satellite. Therefore, an environmental parameter a around the roadside equipment 30 is set in the roadside equipment. The value of a is set to be large when the roadside equipment is located near an obstacle such as a group of buildings, and is set to be small in environment without any obstacle around the roadside equipment.

As for the speed of the own vehicle, it is considered that the speed of the own vehicle upon photographing by the roadside equipment 30 affects the absolute position of the feature point. Let v be a speed of the own vehicle, s be a photographing speed (shutter speed, etc.) of the roadside equipment 30, and Ev be an error in an absolute position of a feature point caused by the speed of the own vehicle. Then the following equation is obtained:

[Equation 1]

Ev=s*v (1)

As for the number of feature points, if a larger number of feature points are detected at one photographing, then an error in the relative position of the receiver to the vehicle body becomes smaller. Let n be the number of detected feature points and Δxi (1 . . . n) be an error in the relative position of the GPS receiver based on the feature points. Then the following equation is obtained:

$$\begin{matrix}[ Equation 2 ] & \\ \frac{\sqrt{{\sum }_{i = 1}^{n} Δ {x}^{2} i}}{\sqrt{n}} & ( 2 )\end{matrix}$$

Here, it is assumed that Δxi depends on a type of feature point, and if the feature point is large or feature points are difficult to be discriminated, then Δxi is set to be larger.

Furthermore, when m represents the number of measurement times, and an error from the external environment, an error in the speed of the own vehicle, and the number of detected feature points are taken into consideration, an error in the relative position of the receiver can be determined as follows:

$$\begin{matrix}[ Equation 3 ] & \\ \frac{\sqrt{{\sum }_{j = 1}^{m} {\sum }_{i = 1}^{n} {( Δ {x}_{ij} + {Ev}_{ij} )}^{2} * {α}_{j}}}{\sqrt{n} * \sqrt{m}} & ( 3 )\end{matrix}$$

An inverse number of the determined value corresponds to the level of reliability. Thus the level of reliability is divided into five levels based on the value, and levels of reliability 1 to 5 are obtained.

As explained so far, in the in-vehicle unit 10 according to the present embodiment, the GPS receiver 11 uses the quasi-zenith satellite to perform positioning with high accuracy, and the result of the positioning is compared with the position of the own vehicle specified by the roadside equipment 30 through image recognition. Based on these processes, the in-vehicle unit 10 specifies the relative position of the GPS receiver 11 to the vehicle body, determines the level of reliability of relative position information, and selects a service using position information to be provided to the user according to the level of reliability. Therefore, it is possible to improve positioning accuracy without burdening users and to provide appropriate services according to the positioning accuracy.

The configurations and operations shown in the present embodiments are only exemplary, and the present invention can be modified and executed as appropriate. For example, a method of calculating the level of reliability, a type of services to be provided, a method of selecting the service, and an external source of acquisition of position information of the own vehicle can be arbitrarily changed.

### INDUSTRIAL APPLICABILITY

As explained above, the vehicle position specifying device, the vehicle position specifying method, and the driving assistance device according to the present invention are useful for specifying the position of the vehicle, and are particularly suitable for providing services using high-accuracy position information.

1. A vehicle position specifying device comprising:
a reception unit that is installed in a vehicle and receives radio waves transmitted from a positioning satellite;
a measurement unit that measures coordinates of the reception unit based on a reception result of the reception unit;
a communication unit that acquires vehicle-position information on a position of an own vehicle from outside the vehicle; and
a calculation unit that calculates an installation position of the reception unit in the vehicle based on the coordinates of the reception unit and the vehicle-position information.

2. The vehicle position specifying device according to claim 1, further comprising an installation-position management unit that manages levels of reliability of the installation position of the reception unit in the vehicle.

3. The vehicle position specifying device according to claim 2, wherein the installation-position management unit calculates the levels of reliability using at least one of external environment, a speed of the own vehicle, a feature point used for image recognition by a roadside equipment, and a number of measurement times of the installation position upon determination of the installation position.

4. The vehicle position specifying device according to claim 2, further comprising a provided-function selection unit that selects a function that can be provided using the vehicle-position information, based on the level of reliability of the installation position.

5. The vehicle position specifying device according to claim 4, wherein the installation-position management unit sets the levels of reliability stepwise, and the provided-function selection unit changes a content of at least one of a route guide function and a collision-avoidance assistance function corresponding to the level of the reliability.

6. A vehicle position specifying method comprising:
receiving, by a reception unit that is installed in a vehicle, radio waves transmitted from a positioning satellite;
measuring coordinates of the reception unit based on a reception result in the receiving step;
acquiring vehicle-position information on a position of an own vehicle from outside the vehicle; and
calculating an installation position of the reception unit in the vehicle based on the coordinates of the reception unit and the vehicle-position information.

7. A driving assistance device comprising:
a reception unit that is installed in a vehicle and receives radio waves transmitted from a positioning satellite;
a measurement unit that measures coordinates of the reception unit based on a reception result of the reception unit;
a communication unit acquires vehicle-position information on a position of an own vehicle from outside the vehicle;
a calculation unit that calculates an installation position of the reception unit in the vehicle based on the coordinates of the reception unit and the vehicle-position information; and
a driving assistance unit that performs at least one of notification to a driver and assistance of control of a vehicle behavior using a measurement result of the measurement unit and a calculation result of the calculation unit.
